(19) United States
(12) Patent Application Publication
(10) Pub. No.: US 2019/0203690 A1
(43) Pub. Date: Jul. 4, 2019

(54) POWER MODULE FOR MACHINE POWER GENERATOR

(71) Applicant: Ernest William Townsend, IV, Scottsdale, AZ (US)

(72) Inventor: Ernest William Townsend, IV, Scottsdale, AZ (US)

(21) Appl. No.: 15/858,842

(22) Filed: Dec. 29, 2017

(51) Int. Cl. F03B 17/00; F03B 17/02

(52) U.S. Cl. CPC F03B 17/00; H02K 53/00; F03B 17/02

(57) ABSTRACT

A power module for moving up and down on a closed loop pathway in a liquid medium is designed for rapid deceleration when traveling in one direction, and also for rapid acceleration when traveling in the opposite direction. To do this, one end of the power module is formed to have a high coefficient of drag, C_{D(L)}, and the opposite end of the power module is formed to have a relatively low coefficient of drag, C_{D(u)}. Specifically, in this combination C_{D(L)} for deceleration is designed to be much greater than C_{D(u)} for acceleration.

### FIELD OF THE INVENTION

The present invention pertains generally to machines and systems for renewably generating electrical energy. More particularly, the present invention pertains to a machine that converts the kinetic energy of an object as it falls from a start point under the influence of gravity into electrical energy, and that then employs the object's buoyancy to return it to the start point for another duty cycle. The present invention is particularly, but not exclusively, useful as a renewable energy machine that uses a bi-level tank to decelerate a power module (i.e. object) after it falls into the tank, and that then accelerates the power module on a return path through the bi-level tank for a buoyant return to the start point.

### BACKGROUND OF THE INVENTION

As intended for the present invention a power module (i.e. object) is directed for travel on a closed path between a high point and a low point. A portion of the path is through the air, and the remainder of the path is through a liquid medium. For purposes of the present invention, the amount of time spent on each portion of the path (air/liquid) is of critical importance. Accordingly, the velocity of the object as it travels along the path must be precisely controlled. In particular, this control involves considerations of the power module's hydrodynamic design. Of particular concern are the capabilities of the object to decelerate and accelerate in the liquid medium portion of the closed path.

In the context of the present invention, a power module needs to sequentially decelerate when traveling downward in a liquid medium under the influence of gravity, and it needs to then accelerate in an upward direction under the influence of its buoyancy. For this sequence, both deceleration and acceleration need to be optimized. Specifically, after entering the liquid medium, deceleration of the power module to zero velocity should be accomplished in a minimized distance as quickly as possible. On the other hand, a subsequent acceleration in the liquid medium from zero velocity to the terminal velocity of the power module in the liquid medium should also be accomplished as quickly as possible. Thus, friction forces on the power module need to be maximized during descent and minimized during ascent, The respective coefficients of pressure for the power module during its descent, C_{D(L)}, and during its ascent, C_{D(u)}, are indicative of these desired responses.

By definition, the Reynolds number, R, of a liquid medium is a dimensionless value that measures the ratio of inertial forces to viscous force in the medium and is used to describe the degree of laminar or turbulent flow of the medium. In the context of the present invention, the Reynolds number of the incompressible liquid medium through which the power module travels is a factor for determining the resistance to movement in the medium that is experienced by the power module. Mathematically, as alluded to above, this resistance can be generalized by a coefficient of drag, C_{D}, which is dependent on such factors as liquid density, viscosity, and power module velocity.

With the above in mind, it is an object of the present invention to design a power module for up and down travel in a liquid medium that will optimize both its deceleration in a downward direction and its acceleration in an upward direction. Another object of the present invention is to optimize the time travel (i.e. velocity control) of a power module as it travels through the liquid segment of a closed loop pathway having both a liquid segment and an air segment. Still another object of the present invention is to provide a power module for use in a renewable energy machine for the generation of electrical energy that is relatively easy to manufacture, is extremely simple to use, and is comparatively cost effective.

### SUMMARY OF THE INVENTION

In accordance with the present invention, a power module is designed to travel on a closed loop path under the influence of gravity from a high launch point to a low pivot point. The power module is then returned by buoyancy from the low pivot point to the high launch point. An important aspect of the present invention is that a portion of the closed loop path passes through a liquid medium in a bi-level tank. For purposes of disclosure, a complete duty cycle for the power module begins and ends at the launch point.

Structurally, the power module has a lower end and it has an upper end. Importantly, the lower end of the power module is formed to have a coefficient of drag, C_{D(L)}, when the power module travels in a liquid medium in a downward direction under the influence of gravity (i.e. “lower end first”). On the other hand, the upper end is formed to have a coefficient of drag, C_{D(u)}, when the power module travels in the liquid medium in an upward direction under the influence of a buoyant force (i.e. “upper end first”). For the present invention, C_{D(L)} is preferably much greater than C_{D(u)} and both coefficients of drag are respectively based on velocity requirements necessary for the power module to complete a closed path duty cycle in a predetermined time. The power module has an axial length, L, and a weight, W, and it preferably has a displacement ratio (i.e. W/liquid volume displaced) in a range between 0.6 and 0.7. Preferably, the weight W of the power module is greater than five hundred pounds.

Individual components of the power module include, in combination, an elongated body that is formed with an enclosed chamber and defines a longitudinal axis. Also included is a lower end portion that is attached in axial alignment with the body. As noted above, the lower end portion is formed with a shape that gives the power module a relatively high coefficient of drag, C_{D(L)}, when it travels through a liquid medium in a downward direction under the influence of gravity. An upper end portion is also attached in axial alignment with the body. The upper end portion, however, is formed with a shape that gives the power module a relatively low coefficient of drag, C_{D(u)}, when the power module travels through a liquid in an upward direction under the influence of a buoyant force, It is an important feature of the power module for the present invention that C_{D(u)} is significantly less than C_{D(L)} (i.e. C_{D(u)}<<C_{D(L)}).

As intended for the present invention, the coefficient of drag C_{D(L)} will decelerate the power module from a velocity attained during the air segment of the duty cycle, to a zero velocity after entering the bi-level tank. This is preferably accomplished within a travel distance less than 3 L while the power module is moving downward by gravity in the liquid medium. On the other hand, the lower coefficient of drag C_{D(u)} will allow the power module to accelerate from a zero velocity to a terminal return velocity, Vᵣ, in the liquid medium within a travel distance less than 3 L while it is moving upward by buoyancy through the liquid medium.

The bi-level tank intended for the present invention includes a transfer tank that is connected in fluid communication with a return tank. In this combination, the transfer tank has a lower level liquid surface, Lᵢₒ, with an access port into the transfer tank that can be alternatively opened or closed. On the other hand, the return tank has an upper level liquid surface, Lₕᵢ, which is always open. Located below Lᵢₒ between the transfer tank and the return tank is a submerged exit port that can be alternatively opened or closed. Importantly, the access port and the exit port are never open at the same time. Thus, the velocity of the power module as it moves through the bi-level tank from the transfer tank and into the return tank must be monitored for compliance with a predetermined time at each point in the duty cycle.

To assist in monitoring the velocity of the power module as it transits through a duty cycle, an accelerometer is mounted on the body of the power module. Also, a transmitter is provided for sending velocity information regarding the power module from the accelerometer to a control unit. Movements of the power module are then monitored by the control unit to ensure compliance with a predetermined schedule for the power module on the closed loop path.

As noted above, a particular purpose envisioned for the power module by the present invention is its use in a renewable energy machine for generating electrical energy. Accordingly, in a preferred embodiment of the power module, either a plurality of permanent magnets or, alternatively, a plurality of coils can be embedded in the body of the power module to establish a solenoid configuration for an electric power generator. For this embodiment, as the power module falls during the air segment of the duty cycle, the magnets/coils can interact with external coils/magnets surrounding that portion of the closed loop liquid tank which is external to the bi-level tank. For an alternate embodiment, the power module can include a gripping device that will interact with a drive chain as it falls during the air segment of the duty cycle. Subsequently, for either embodiment the bi-level tank can be used to first decelerate the power module, and then allow for an acceleration of the power module out of the bi-level tank.

Refined aspects of the present invention of the power module for the present invention include the possibility that the upper end portion of the power module is generally dome shaped to optimally minimize C_{D(u)}, and thereby maximize the power module's ability to accelerate. On the other hand, the lower end portion of the power module generally has a blunted shape to maximize C_{D(L)}, and thereby maximize the power module's ability to decelerate. As an additional feature, a plurality of spoilers can be mounted on the lower end portion of the power module to enhance its deceleration capability. For purposes of the present invention the power module can be made of a metal, a heavy duty plastic, or of any other rigid material known in the pertinent art that is rigid and inflexible under the stress-strain conditions encountered by a power module during a duty cycle. Also for this purpose, the enclosed chamber of the power module can be filled with a light weight material, or include a truss-like structure that is incorporated into the enclosed chamber to enhance the rigidity required for the present invention. The important considerations to be balanced here are: i) the rigidity requirements just discussed, and ii) the creation of an appropriate displacement ratio for the power module that will create a suitable buoyant force on the power module.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is an upper end perspective view of the power module in accordance with the present invention;

FIG. 1B is a lower end perspective view of the power module in accordance with the present invention;

FIG. 2 is a cross-section view of the power module as seen along the line 2-2 in FIG. 1A; and

FIG. 3 is a schematic view of the orientation of a power module as it travels along a closed path relative to a bi-level tank in accordance with the present invention.

### DESCRIPTION OF THE PREFERRED EMBODIMENTS

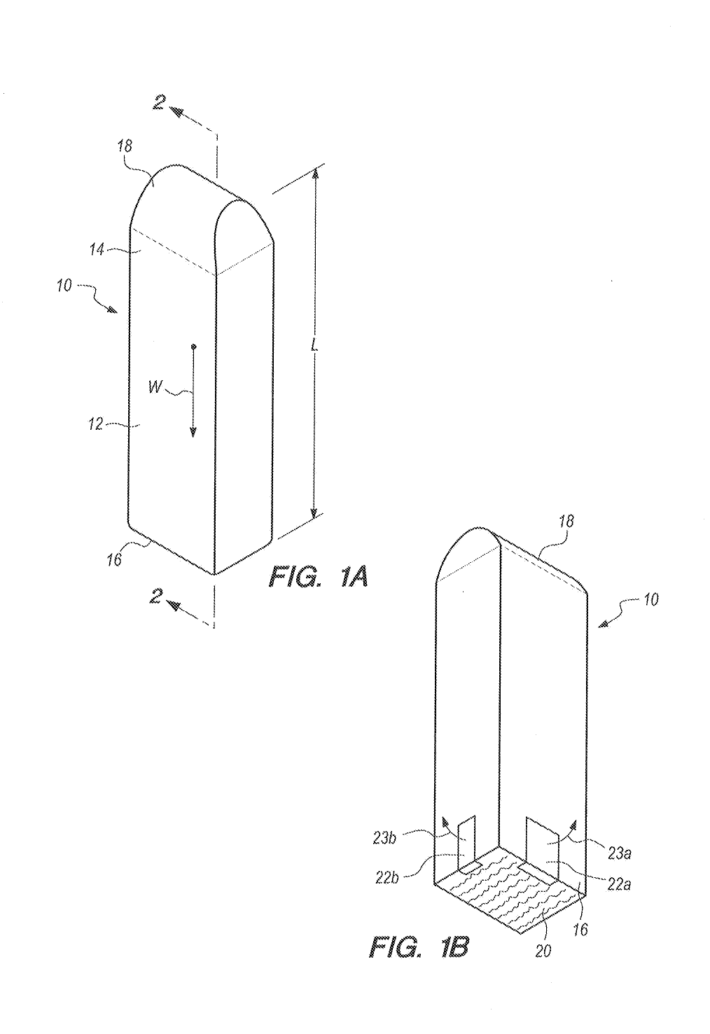

Referring initially to FIG. 1A, a power module in accordance with the present invention is shown and is generally designated 10. As shown, the power module 10 has an elongated body 12 with an upper end 14 and a lower end 16. FIG. 1A also shows that the upper end 14 is formed with an upper end portion 18, and FIG. 1B shows that the lower end 16 is formed with a lower end portion 20.

In detail, the upper end portion 18 is formed with a smooth hydrodynamic surface which will give the power module 10 a relatively low coefficient of drag, C_{D(u)}, when traveling in a direction with its upper end 14 first, in a liquid medium. For this purpose, the upper end portion 18 will typically have a hydrodynamic shape that is designed using well known marine architecture techniques (e.g. some form of dome shaped contour). On the other hand, as shown in FIG. 1B, the lower end portion 20 of the power module 10 is formed with a rough, textured and typically flat surface which will give the power module 10 a relatively high coefficient of drag, C_{D(L)}, when it is traveling in a direction with its lower end 16 first, in a liquid medium.

It is an important feature of the present invention that C_{D(u)} is much lower than C_{D(L)} (i.e. C_{D(u)}<C_{D(L)}). As will become more apparent with a consideration of disclosure presented below, the relative difference between C_{D(u)} and C_{D(L)} is a design feature that allows the power module 10 to accelerate quickly in a liquid medium and, likewise, to decelerate quickly in the liquid medium. Further, to enhance the deceleration capability of the power module 10, FIG. 1B shows that spoilers 22 can be deployed as indicated by respective arrows 23a and 23b (note: spoilers 22a and 22b are only exemplary).

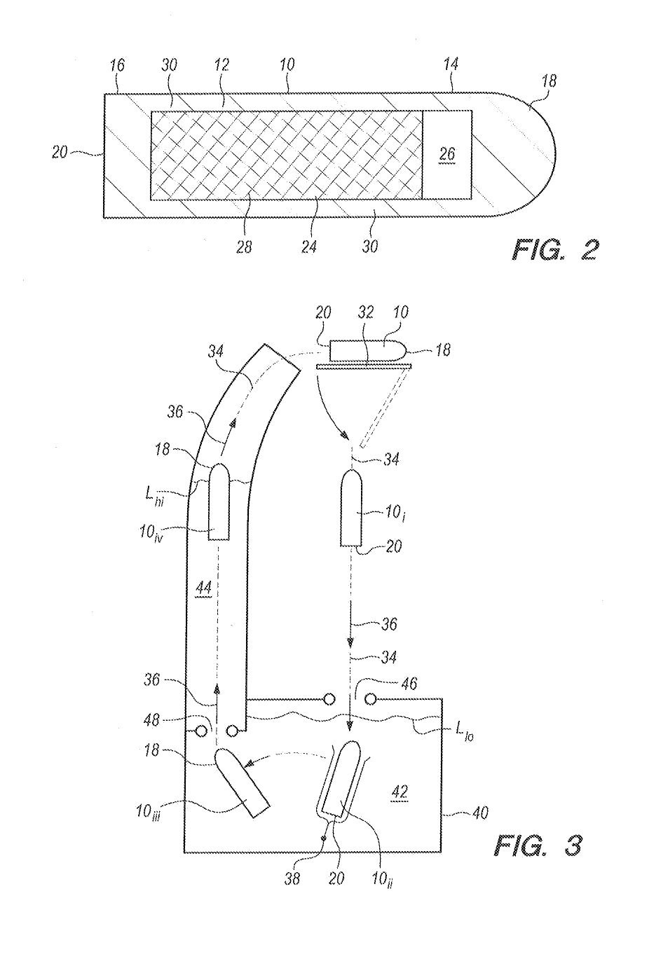

Referring now to FIG. 2, a cross-section of the power module 10 shows that the power module 10 is formed with an interior, enclosed chamber 24. As shown in FIG. 2, the enclosed chamber 24 includes an electronics bay 26 where electronic devices such as sensors and transmitters can be located. In particular, sensors (e.g. accelerometers which are not shown) and a transmitter (also not shown) can be of types well known in the pertinent art that are used for the purpose of collecting velocity information which is descriptive of the movements of the power module 10. As intended for the present invention, this velocity information will be transmitted to a control unit (also not shown), where movements of the power module 10 can be monitored.

Still referring to FIG. 2 it will be seen that a truss 28 and/or an extremely light weight structural material (not shown) are positioned inside the enclosed chamber 24 of the power module 10, in contact with the sidewalls 30 of the power module 10. The purpose here is to reinforce the sidewalls 30, and thereby prevent unwanted distortion or deformation of the power module 10 during its operation. Further, as a design feature, the power module 10 will have a gross volume vₘ and a weight W. Importantly, for purposes of providing buoyancy for the power module 10, displacement ratio W/vₘ for the power module 10 will preferably he in a range of 0.6 to 0.7.

Operational aspects of the present invention will be best appreciated with reference to FIG. 3. There it will be seen that an intended duty cycle for a power module 10 begins at a high launch point 32 and continues from there on a closed path 34. The direction of travel of the power module 10 on the closed path 34 is indicated by the arrows 36. Thus, it will be seen that the closed path 34 begins at the high launch point 32, and proceeds to a pivot point 38 in a bi-level tank 40 for a return to the high launch point 32, where the closed path 34 ends and another duty cycle begins.

In FIG. 3, a simplified schematic of the bi-level tank 40 shows that the bi-level tank 40 includes a transfer tank 42 which is connected in fluid communication with a return tank 44. In this combination, the transfer tank 42 has a lower level liquid surface, Lᵢₒ, with an access port 46 into the transfer tank 42 which can be operationally opened and closed. On the other hand, the return tank 44 has a continuously open, upper level liquid surface, Lₕᵢ. A submerged exit port 48, which can be opened only when the access port 46 is closed, is located between the transfer tank 42 and the return tank 44. With the above in mind, the essence of the present invention will be appreciated by considering the travel of a power module 10 as it moves along the closed path 34. From the high launch point 32, the power module 10 is launched onto the closed path 34, to fall toward the bi-level tank 40 under the influence of gravity, At first the module 10ᵢ is shown traveling in a downward direction with its lower end portion 20 first. Note: during this air segment of the closed path 34, the kinetic energy of the power module 10ᵢ can be used for energy transfer purposes (e.g. generation of electric power). Power module 10ᵢᵢ then enters the transfer tank 42 through an open access port 46, with its lower end portion 20 first. The power module 10ᵢᵢ than decelerates to zero velocity under the influence of its buoyancy and the effects of the high coefficient of drag, C_{D(L)}. From zero velocity at its pivot point 38 in the transfer tank 42, the power module 10ᵢᵢᵢ then accelerates in an upward direction under the influence of its buoyancy. Importantly, when moving in the upward direction the upper end portion 18 of power module 10ᵢᵢᵢ, with its lower coefficient of drag, C_{D(u)}, is now first. As intended for the present invention, the power module 10ᵢᵥ will accelerate to a terminal return velocity, Vᵣ. Preferably, Vᵣ is attained before it has traveled more than a distance 3 L in the liquid medium of the bi-level tank 40. Power module 10ᵢᵥ then travels at Vᵣ on the closed path 34 until it is ejected from the return tank 44 and back to the high launch point 32.

While the particular Power Module for Machine Power Generator as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A power module having a lower end and an upper end, wherein the lower end is formed to have a coefficient of drag, C_{D(L)}, when the power module travels in a liquid medium in a downward direction under the influence of gravity (“lower end first”), and wherein the upper end is formed to have a coefficient of drag, C_{D(u)}, when the power module travels in the liquid medium in an upward direction under the influence of a buoyant force (“upper end first”), wherein the downward direction is opposite to the upward direction, wherein C_{D(L)} is greater than C_{D(u)} and both C_{D(L)} and C_{D(u)} are respectively based on velocity requirements necessary for the power module to complete a closed path duty cycle in a predetermined time.

2. The power module of claim 1 wherein the power module is elongated, has an axial length, L, and a weight, W, and wherein C_{D(u)} is less than C_{D(L)} (i.e. C_{D(u)}<C_{D(L)}) and the power module has a displacement ratio in a range between 0.6 and 0.7.

3. The power module of claim 2 wherein the power module decelerates to zero velocity within a travel distance less than 3 L while moving by gravity through the liquid medium in the downward direction, and accelerates to a terminal return velocity, Vᵣ, within a travel distance less than 3 L while moving by buoyancy through the liquid medium in the upward direction.

4. The power module of claim 3, wherein the power module travels by gravity on a closed loop path from a high launch point to a low pivot point with a return by buoyancy from the low pivot point to the high launch point, and a complete duty cycle for the power module begins and ends at the high launch point, and wherein a portion of the closed loop path passes through the liquid medium in a bi-level tank.

5. The power module of claim 4 wherein the bi-level tank includes a transfer tank connected in fluid communication with a return tank, wherein the transfer tank has a lower level liquid surface, Lᵢₒ, with a covered access part into the transfer tank, and the return tank has an open upper level liquid surface, Lₕᵢ, with a submerged exit port located between the transfer tank and the return tank, wherein the bi-level tank receives the power module for transit therethrough at a predetermined time in the duty cycle.

6. The power module of claim 5 wherein permanent magnets are embedded in the body of the power module for generating electric power when the magnets interact with external coils surrounding a portion of the closed loop liquid tank external to the bi-level tank as the power module falls from the high launch point and into the transfer tank during a duty cycle.

7. The power module of claim 4 further comprising:
an accelerometer mounted on the body; and
a transmitter for sending velocity information regarding the power module to a control unit where movements of the power module are monitored to ensure compliance with a predetermined schedule for the power module on the closed loop path.

8. A power module which comprises:
a body formed with an enclosed chamber, wherein the body defines a longitudinal axis;
a lower end portion attached to the body in axial alignment therewith, wherein the lower end portion is formed with a shape having a coefficient of drag, C_{D(L)}, when the power module travels through a liquid medium in a first axial direction; and
an upper end portion attached to the body in axial alignment therewith, wherein the upper end portion is formed with a shape having a coefficient of drag, C_{D(u)}, when the power module travels through the liquid medium in a second axial direction, wherein the first axial direction is opposite to the second axial direction.

9. The power module of claim 8 wherein the power module has an axial length, L, and a weight, W, and wherein C_{D(u)} is less than C_{D(L)} (i.e. C_{D(u)}<C_{D(L)}) and the power module has a displacement ratio in a range between 0.6 and 0.7, and wherein the power module decelerates to zero velocity within a travel distance less than 3 L while moving by gravity through the liquid medium in the first direction, and accelerates to a terminal return velocity, Vᵣ, within a travel distance less than 3 L while moving by buoyancy through the liquid medium in the second direction.

10. The power module of claim 8, wherein the power module travels by gravity on a closed loop path from a high launch point to a low pivot point with a return by buoyancy from the low pivot point to the high launch point, and a complete duty cycle for the power module begins and ends at the high launch point, and wherein a portion of the closed loop path passes though the liquid medium in a bi-level tank.

11. The power module of claim 10 wherein the bi-level tank includes a transfer tank connected in fluid communication with a return tank, wherein the transfer tank has a lower level liquid surface, Lᵢₒ, with a covered access port into the transfer tank, and the return tank has an open upper level liquid surface, Lₕᵢ, with a submerged exit port located between the transfer tank and the return tank, wherein the bi-level tank receives the power module for transit therethrough at a predetermined time in the duty cycle.

12. The power module of claim 11 further comprising:
an accelerometer mounted on the body; and
a transmitter for sending velocity information regarding the power module to a control unit where movements of the power module are monitored to ensure compliance with a predetermined schedule for the power module on the closed loop path.

13. The power module of claim 10 wherein permanent magnets are embedded in the body of the power module for generating electric power when the magnets interact with external coils surrounding a portion of the closed loop liquid tank external to the bi-level tank as the power module falls from the high launch point and into the transfer tank during a duty cycle.

14. The power module of claim 8 wherein the upper end portion of the power module is dome shaped to optimally minimize C_{D(u)}, and the lower end portion of the power module has a blunted shape to optimally maximize C_{D(L)}.

15. The power module of claim 14 further comprising a plurality of spoilers mounted on the lower end portion of the power module.

16. The power module of claim 8 wherein the power module is made of a rigid material.

17. The power module of claim 8 wherein the weight W of the power module is greater than five hundred pounds.

18. A method for manufacturing a power module which comprises the steps of:
providing a body formed with an enclosed chamber, wherein the body defines a longitudinal axis and has a first end and a second end;
affixing a lower end portion to the first end of the body in axial alignment therewith, wherein the lower end portion is formed with a shape having a coefficient of drag, C_{D(L)}, when the power module travels through a liquid medium in a first axial direction; and
affixing an upper end portion to the second end of the body in axial alignment therewith, wherein the upper end portion is formed with a shape having a coefficient of drag, C_{D(u)}, when the power module travels through the liquid medium in a second axial direction.

19. The method of claim 18 wherein the first axial direction is opposite to the second axial direction, wherein C_{D(u)} is less than C_{D(L)} (i.e. C_{D(u)}<C_{D(L)}), and wherein the power module has a volume, vₘ, and a weight, W, and the power module has a displacement ratio, W/vₘ, for buoyancy in a range between 0.6 and 0.7.

20. The method of claim 18 further comprising:
mounting an accelerometer on the body of the power module; and
transmitting velocity information regarding the power module to a control unit where movements of the power module are monitored to ensure compliance with a predetermined schedule for the power module on the closed loop path, wherein permanent magnets are embedded in the body of the power module for generating electric power when the magnets interact with external coils surrounding a portion of the closed loop liquid tank external to the bi-level tank as the power module falls from the high launch point and into the transfer tank during a duty cycle, wherein the upper end portion of the power module is dome shaped to optimally minimize C_{D(u)}, and the lower end portion of the power module has a blunted shape to optimally maximize C_{D(L)}, and wherein the weight W of the power module is greater than five hundred pounds.
